(19) United States
(12) Patent Application Publication
(10) Pub. No.: US 2016/0067740 A1
(43) Pub. Date: Mar. 10, 2016

(54) THREE DIMENSIONAL (3D) PRINTER WITH A BUILD PLATE HAVING MULTI-DEGREE OF FREEDOM MOTION

(71) Applicant: DISNEY ENTERPRISES, INC., BURBANK, CA (US)

(72) Inventors: JEFFREY VORIS, PASADENA, CA (US); BENJAMIN FOSTER CHRISTEN, LOS ANGELES, CA (US); JORGE ALTED, ALTADENA, CA (US); DAVID W. CRAWFORD, LONG BEACH, CA (US)

(73) Assignee: DISNEY ENTERPRISES, INC., BURBANK, CA (US)

(21) Appl. No.: 14/480,782

(22) Filed: Sep. 9, 2014

(51) Int. Cl. B05D 1/26; B05C 5/02

(52) U.S. Cl. CPC B05D 1/265; B05C 5/02

(57) ABSTRACT

A three dimensional (3D) for printing a 3D object without the need for printing support structure for overhanging or cantilevered portions of the 3D object. The 3D printer includes a print head with a nozzle for extruding print material and a build plate with an upper surface receiving the print material extruded from the nozzle, whereby the 3D object is formed on the upper surface of the build plate. The 3D printer includes a tilt adjustment mechanism tilting the build plate about at least one axis to orient the upper surface and the 3D object relative to the nozzle during the extruding of the print material. The tilting can be performed such that a previously extruded portion of the print material is vertically aligned with the nozzle to receive the print material extruded to form an overhanging element of the 3D object.

### BACKGROUND

1. Field of the Description

The present invention relates, in general, to fabrication of three dimensional (3D) objects, and, more particularly, to a 3D printer adapted to print a 3D object of a digital model having overhanging or cantilevered elements without a need for printing support structures for the overhanging or cantilevered elements.

2. Relevant Background

Presently, 3D printing is a fabrication technology in which objects (or “printed 3D objects”) are created from a digital file, which may be generated from software such as a computer aided design (CAD) program or another 3D modeling program or with a 3D scanner to copy an existing object that provides input to a 3D modeling program. To prepare the digital file for printing, software that is provided on a printer-interfacing computer or running on the 3D printer itself slices or divides the 3D model into hundreds-to-thousands of horizontal layers. Typically, only the outer wall or “shell” is printed to be solid such that a shell thickness may be defined as part of modifying the 3D model for use in printing. Then, during printing, the shell is printed as a solid element while the interior portions of the 3D object are printed in a honeycomb or another infill design, e.g., to reduce the amount of material that has to be printed to provide the printed 3D object.

When the prepared digital file of the 3D object is uploaded into the 3D printer, the 3D printer creates or prints the object layer-by-layer on a build plate or build platform. The 3D printer reads every slice (or 2D image) from the 3D model and proceeds to create the 3D object by laying down (or printing) successive layers of material on an upper, planar surface of the build plate until the entire object is created. Each of these layers can be seen as a thinly sliced horizontal cross section of the eventually completed or printed 3D object.

One of the more common 3D printer technologies uses fused deposition modeling (FDM) or, more generally, fused filament fabrication (FFF). FDM printers work by using a plastic filament (e.g., acrylonitrile butadiene styrene (ABS) or polylactic acid (PLA) provided as strands of filament that is 1 to 3 millimeters in diameter) that is unwound from a spool mounted onto the printer housing. The plastic filament is used to supply material to a print head with an extrusion nozzle, e.g., a gear pulls the filament off the spool and into the extrusion nozzle. The extrusion nozzle is adapted to turn its flow on and off. The extrusion nozzle (or an upstream portion of the print head) is heated to melt the plastic filament as it is passed into the extrusion nozzle so that it liquefies. The extrusion nozzle deposits the liquefied material in ultra fine lines, e.g., in lines that are about 0.1 millimeters across.

The extrusion head and its outlet are moved, in both horizontal and vertical directions to complete or print each layer of the 3D model, by a numerically controlled mechanism that is operated by control software running on the 3D printer, e.g., a computer-aided manufacturing (CAM) software package adapted for use with the 3D printer. The build plate is typically stationary with its upper planar surface parallel to a horizontal plane (or horizontal to the nozzle or its printed layers). If the build plate is moved at all, it is only moved up and down vertically (i.e., in the z-direction). The extruded melted or liquefied material quickly solidifies to form a layer (and to seal together layers of the 3D object), and the extrusion nozzle is then moved vertically prior to starting the printing of the next layer. This process is repeated until all layers of the 3D object have been printed.

A problem with existing 3D printing techniques is the need for printing a support structure for any overhanging (or cantilevered) components of a 3D object. For example, a figurine of a human-like character may have its arms extending outward from its body or torso, and the arms would be cantilevered out from the body or overhang from the adjacent portions of the body. A support structure would have to be included in layers that are printed below or in advance of the overhanging components or portions of the 3D object to provide material upon which to print the overhanging components. This slows the printing process further as a significant amount of material may have to be printed to provide the support structure, which can waste a large amount of material (e.g., plastic filament).

Additionally, upon completion of printing, the 3D object requires finishing including removal of the support structure and, in some cases, sanding or polishing of the surfaces from which the support structure was removed to match the finish of adjacent surfaces. These additional steps also increase the production time of the 3D object and typically must be performed manually, which further increases fabrication costs and complexities.

Hence, it would be desirable to provide a 3D printing method, and associated 3D printer, that can print a 3D object without the need to print support structures for each overhanging or cantilevered element or portion of the 3D object.

### SUMMARY

A 3D printer, and print method carried out by the 3D printer, is described that allows a 3D object to be printed without printing additional support structure. The 3D printer includes a build plate that is supported upon a tilt adjustment mechanism (or print angle-defining mechanism or assembly). The tilt adjustment mechanism or assembly acts to orient the build plate's upper surface relative to a print nozzle (e.g., an extrusion nozzle or other deposition mechanism outlet) such that existing model structure or previously printed/deposited layers or 3D object material is directly below the print nozzle.

The tilt adjustment mechanism may take the form of a multi-degree of freedom motion system such as a Stewart's platform or another useful form for selectively changing the angle of the upper surface of the build plate by tilting or rotating the plate about one axis or about two axes. In one embodiment, the tilt adjustment assembly includes a rotating or rotatable build plate and one or more motors for adjusting the angular orientation of the build plate (e.g., a tilt motor for rotating or tilting the build plate about a tilt axis and, optionally, a yaw motor for orienting the plate with yaw movements).

More particularly, an apparatus or 3D printer is provided for generating (or “printing”) a physical three dimensional (3D) object without the need for printing support structure for overhanging or cantilevered portions of the 3D object. The 3D printer includes a print head with a nozzle for extruding print material (e.g., ejecting liquefied or melted plastic). The 3D printer also includes a build plate with an upper surface receiving the print material extruded from the nozzle, whereby the 3D object is formed on the upper surface of the build plate. Further, the 3D printer includes a tilt adjustment mechanism (or print angle-defining assembly) supporting the build plate and tilting the build plate about at least one axis to orient the upper surface and the 3D object relative to the nozzle during the extruding of the print material from the print head.

In some embodiments, after a first layer of the print material is extruded upon the upper surface, the tilting is performed such that a previously extruded portion of the print material is vertically aligned with the nozzle to receive the print material extruded to form an overhanging element of the 3D object. In the same or other embodiments, during the extruding of the print material from the nozzle, the tilting sets a tilt angle of the build plate to a plurality of differing angles in the range of 0 to 60 degrees as measured between a horizontal plane and the upper surface. In other cases, the tilt angle may be even larger such as in the range of 0 to 75 degrees or more.

In some implementations, the 3D printer may include a print controller operating the print head and the tilt adjustment mechanism (e.g., with tilt control signals) to extrude the print material from the nozzle in a plurality of layers defined in a print model of the 3D object with each of the layers having a plurality of print locations. The tilting provided to the build plate to orient the upper surface is defined for each of the print locations in each of the layers. The print model may include an overhanging element of the 3D object, and the tilting can be defined to position the print material of a previously extruded one of the layers vertically below the nozzle during the printing of portions of the layers associated with the overhanging element. In this way, no additional support structure is provided for the 3D object during the extruding of the print material.

In some cases, the tilt adjustment mechanism is configured to provide multi-degree of motion of the build plate during the tilting, and, particularly, the tilt adjustment mechanism can be configured as a Stewart platform. In other cases, the build plate may be provided as a rotatable disk, and the tilt adjustment mechanism can then be configured to tilt the rotatable disk about a tilt axis to orient the upper surface relative to the nozzle during the extruding of the print material. Further, the tilt adjustment mechanism can be configured to provide yaw movement of the build plate during the tilting to orient the upper surface relative to the nozzle.

### BRIEF DESCRIPTION OF THE DRAWINGS

FIG. 1 is a functional block diagram of a 3D printer with a build plate that is angularly oriented or tilted (on 1 axis or 2 axes) during its use or operation to print or create a 3D object without the need for printing a support structure;

FIG. 2 is a flow diagram for a method of fabricating or printing a 3D object without printing support material under overhanging portions using a 3D printer of the present description such as the 3D printer of FIG. 1;

FIG. 3 is a partial side view of a conventional 3D printer printing a 3D object with overhanging portions or features by printing additional or support material in each layer to support the material on a horizontal build plate surface;

FIG. 4 is a side perspective view of a 3D printer of the present description during its operation to print a 3D object without printing additional support structure for overhanging portions or features in upper layers;

FIG. 5 is an enlarged (or detail) partial side view of the 3D printer of FIG. 4 showing features of one embodiment of a tilt mechanism (or plate positioning assembly) operating to orient or tilt the upper surface of the build plate at a predefined angle to position previously printed layers or material of the 3D object below the print nozzle (or heated extrusion nozzle);

FIG. 6 a top perspective view of the 3D printer of FIGS. 4 and 5 showing use of the 3D printer to print an outer shell and in-fill portions of the 3D object without printing additional support structure;

FIG. 7 illustrates a front view another exemplary 3D printer of the present description showing use of a tilt mechanism or build plate positioning assembly with a rotating/rotatable build plate that can also be tilted to provide a desired angular orientation relative to a print nozzle;

FIG. 8 is a side view of the 3D printer of FIG. 7 showing more details of the tilt mechanism; and

FIG. 9 is a detailed front view of the 3D printer of FIGS. 7 and 8.

### DETAILED DESCRIPTION

The inventors recognized that existing or conventional 3D printers, such as FFF-based 3D printers, are extremely slow in printing a 3D object. Further, conventional 3D printers require that support structure must be printed for any overhanging portions of the 3D object, which further slows the printing process and requires post-printing fabrication steps to remove the support structure.

To address these and other issues with conventional 3D printers, a 3D printer is taught that is adapted to constantly reposition the build plate (or its planar upper surface) relative to the print material outlet of the 3D printer (e.g., relative to the extrusion or print nozzle in a fused filament fabrication (FFF) printer). Briefly, the build plate and a partially formed 3D object on the upper surface of the build plate are tilted or angularly oriented relative to the print nozzle such that previously printed and hardened material in lower print layers is vertically and/or directly below the print nozzle as it prints at a next location. In other words, the partially formed or printed 3D object may have its overhanging element vertically aligned with the nozzle when new material is applied to the 3D object to grow or further print the overhanging element.

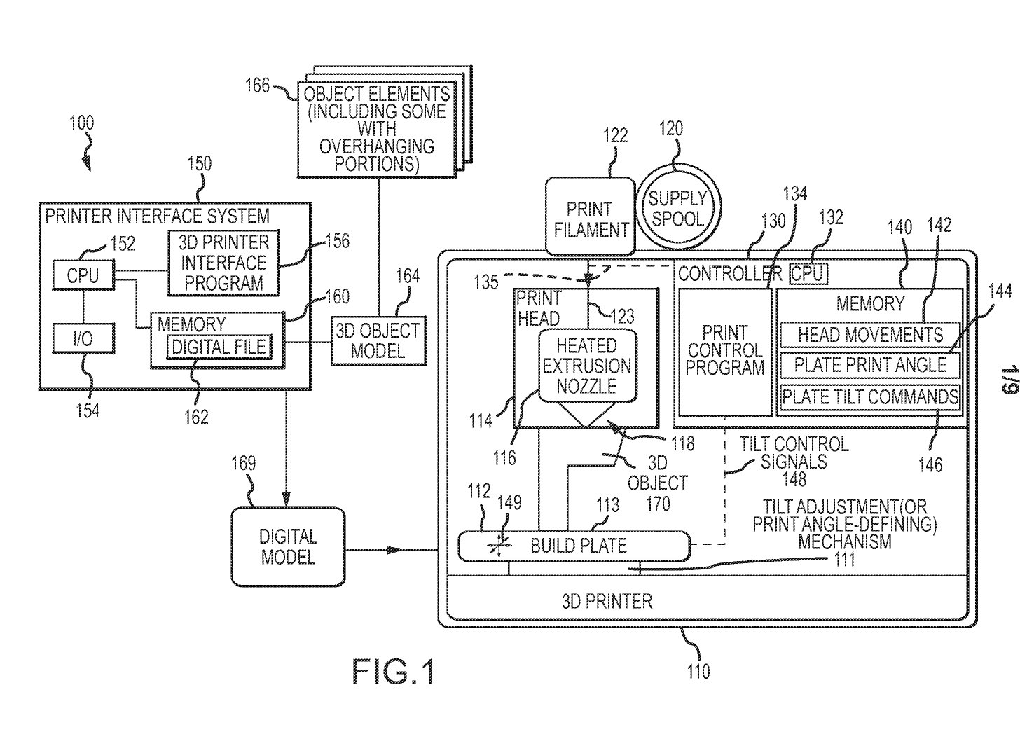

FIG. 1 illustrates a 3D print system 100 configured to allow an operator to print 3D objects, such as object 170, that may have overhanging elements or portions 176 but that can be formed without the need for printing additional support structure for these elements/portions (i.e., no support structure is shown below (or between the plate 113 and the elements 176) the overhanging elements or portions 176). As shown, the system 100 includes a 3D printer 110 and a printer interface system 150. The printer interface system 150 may be a desktop computer, a workstation, a laptop or pad computer, or other computer device operable by a user of the 3D printer 110 to select and transmit a digital model 169 to the 3D printer 110 for use in printing a 3D object 170. To this end, the printer interface system 150 includes a processor or central processing unit (CPU) 152 that operates or manages input and output (I/O) devices 154 such as a monitor, a touchscreen, a mouse, a keyboard, speakers, voice recognition devices, and the like that allow an operator or user of the system 150 to provide user input.

Particularly, the printer interface system 150 may include memory devices or data storage components (e.g., computer readable medium) 160 (or have access to such memory devices) that are managed by the processor 152 to store one or more digital files 162 that are used to print a 3D object 170. Also, the system 150 may use the CPU 152 to execute code or software (in computer readable medium such as RAM, ROM, or the like on the system 150) in the form of a 3D printer interface program 156. The interface program 156 may be downloaded onto the system 150 to allow an operator to interact with the 3D printer 110 and its print controller 130, and the 3D printer 110 may provide this software/program 156 upon a first link of the system 150 and the 3D printer 110 or the software/program 156 may be downloaded separately (e.g., by inserting a CD into the system 150, by accessing a web site associated with the 3D printer 110, or the like).

In practice, the 3D printer interface program 156 may be adapted to cause a series of interface screens to be presented by the system 150 and the I/O devices 154 to a user. The user may select a 3D object for printing by first generating a 3D model 164 of a 3D object, and this definition may also include setting a thickness for an outer shell of object 170 and a structural infill (e.g., one or more honeycomb patterns). Significantly, the 3D object model 164 may include a plurality of object elements or portions 166, and one or more of these object elements or portions 166 may be fully, or have a portion that is, overhanging or cantilevered relative to other portions that are fully supported by lower layers or portions of the 3D object. The 3D printer 110 is configured to allow these overhanging portions of the object elements 166 or the overhanging elements 166 to be printed without printing additional support structure that would have to later be removed from the 3D object 170 (as was the case with prior 3D printer with build plates that were always in a horizontal position).

During operation of the system 100, the printer interface system 150 functions to communicate (wirelessly or in a wired manner) with the 3D printer 110 including transmitting a digital model 169 (or sending the digital file 162) to the 3D printer 110 for use by the print control program 134 to print a 3D object 170 (in other cases, the print control program 134 accesses the digital file 162 in the memory 160, as needed for printing, rather than transmitting the model 169 to the 3D printer).

The 3D printer 110 includes a build plate or print bed 112 with an upper or exposed planar surface 113 upon which melted plastic is printed from a print head 114 to form a 3D object 170. The object 170 has a first or base element or portion 172 that may be printed first upon the surface 113 of the build plate 112. Even with conventional 3D printers this portion 172 does not require a support structure such that the build plate 112 may be maintained in a horizontal position (i.e., with planar upper surface 113 parallel to a horizontal plane or parallel to horizontal). Additionally, the object 170 has a second or upper element or portion 174 that is supported by the first or base element or portion 172, and, again, the material of this second element 174 would not require an additional support structure even with a conventional 3D printer such that the surface 113 of build plate 112 may be retained in a horizontal position (as shown).

However, the object 170 also includes a third element or portion 175 that is overhanging or cantilevered from the second or upper element or portion. If a conventional 3D printer were used to print the object 170, an additional support structure would have to be printed prior to printing the element 176. Hence, the 3D printer 110 is adapted to tilt or adjust the print angle of the surface 113, as shown with arrows 149 showing multi-degree of freedom movement of the plate 113 and its upper surface 113, in an ongoing manner during extrusion of melted filament 122 through the nozzle 116.

To this end, the 3D printer 110 includes a tilt adjustment (or print angle-adjusting) mechanism 111 that acts to support the build plate 112 and to adjust or change the tilt or print angle of the upper surface 113 such that material in lower layers (or previously printed layers) is always positioned vertically below the next print position or location. In the example shown in FIG. 1, the tilt adjustment mechanism 111 would move 149 the build plate 112 so as to tilt the surface 113 and the in-process object 170 so that printed material in the layers of first or base element 172 and/or of second or upper element 174 are vertically below the nozzle 116 to provide support for the material in overhanging element 176 (or its layers), without the need for additional support structure. This may involve adjusting the tilt angle, as measured between the surface 113 and horizontal, on a nearly continuous manner or on a print location-by-print location basis. The tilting may be performed along one axis or two axes to provide the desired tilt adjustments. The tilt adjustment mechanism 111 may take a variety of forms to implement the 3D printer 110 by providing a build plate 112 with an upper print surface 113 that can be selectively moved with multi-degree of freedom motion so as to move support material in the object 170 vertically below the nozzle 116 and its pointed tip/outlet 118. Several examples of useful tilt adjustment mechanisms are described herein, but those skilled in the art will recognize that other mechanisms or assemblies may be used to provide the functionality described herein.

The 3D printer 110 includes a print head 114 with a heated extrusion nozzle 116 with a pointed tip/outlet 118 from which liquid plastic is ejected or extruded to build up the object 170 layer-by-layer. In some cases, the heated extrusion nozzle 116 may include a heater or heat coil about a tube while in other cases a heated chamber is provided immediately upstream of the tip/outlet 118 to liquefy or melt plastic to prior to extrusion. Further, the 3D printer 110 includes a print material supply in the form of a supply spool 120 upon which is wrapped or wound a length of plastic that can be drawn as shown by arrow 123 into the extrusion nozzle 116 where it is melted or liquefied by a heater. For example, the filament 122 may take the form of ABS, PLA, or other plastic useful in 3D printing.

The 3D printer 110 includes a controller 130 for interfacing with the printer interface system 150 so as to print a 3D object 170 based on the digital file 162. The controller 130 includes a processor 132 executing or running software/code in the form of a print control program 134 (e.g., code in computer readable media accessible by the CPU 132). The print control program 134 is configured to selectively cause the filament 122 to be drawn (e.g., with gearing or the like) 123 from the spool 120 into the head 114 while also selectively moving 149 the build plate 112 to provide support material for printed material using previously printed or lower layers of the object 170. The print control program 134 also may operate to move the print head 114 within a layer and to a new layer to print the 3D object 170 (e.g., to provide 3D printing, layer-by-layer as is known by those skilled in the art of 3D printing).

To provide support below all layers of the object even in the cantilevered or overhanging elements 176, the print control program 134 is designed to cause the controller 130 to transmit tilt control signals 148 to the tilt mechanism 111 that cause it to either retain the present tilt of the upper surface 113 or to adjust its angle or tilt by reorienting 149 the build plate, which may involve tilting the plate relative to one or more axes. The tilt control signals 148 are typically based on print parameters that are generated and/or calculated prior to printing by processing the digital model 169. For example, the digital model 169 of the 3D object 164 may be processed by the print control program (or another program in the system 100) 134 to slice the model 169 into a plurality of layers and for each layer head movements 142 may be defined to allow the 3D object to be printed layer-by-layer. The head movements 142 may be stored in memory or data storage of the printer 110 (or stored in another memory device accessible by the print control program 134 during printing).

Further, for each print position or location in each layer, the print control program 134 can determine whether or not there is support material in a lower or previously printed layer. If there is support material, such as for all the layers of base 172 and for the second or upper element 174 of object 170, the print control program 134 can determine the surface 113 can remain horizontal (or have its tilt angle unchanged), and the plate print angle 144 associated with that print location can be stored in the memory 140 (e.g., at each X-Y coordinate of each print layer a tilt angle or print angle or plate orientation will be defined by the print control program 134). If there is no support material provided at a print location in a layer if the plate surface 113 were left in the horizontal position, the print control program 134 determines a tilt or print angle needed to place support material from a lower or prior print layer (or adjacent portion) of the 3D object below the present print location. The tilt or print angle 144 is also stored in memory 140 for this print location. This process is repeated for each layer and each print location in each layer.

The print control program 134 further acts to generate a set of plate tilt commands 146 that are designed for the specific implementation of the tilt adjustment mechanism 111 to cause it to orient 149 the build plate 112 at each print location in each layer so as to provide support material below the outlet 118 of the heated nozzle 116. The head movements 142 are used to generate head positioning signals 135 while the corresponding plate tilt commands 146 are used to generate tilt control signals 148 that are transmitted to the tilt adjustment mechanism 111 during the printing of the 3D object 170. In this manner, the build plate 112 is oriented and/or positioned as shown with arrows 149 prior to each deposition or printing step performed by the 3D printer 110 to ensure a previously printed portion of the object 170 is below the outlet 118 prior to extrusion of the print filament 122.

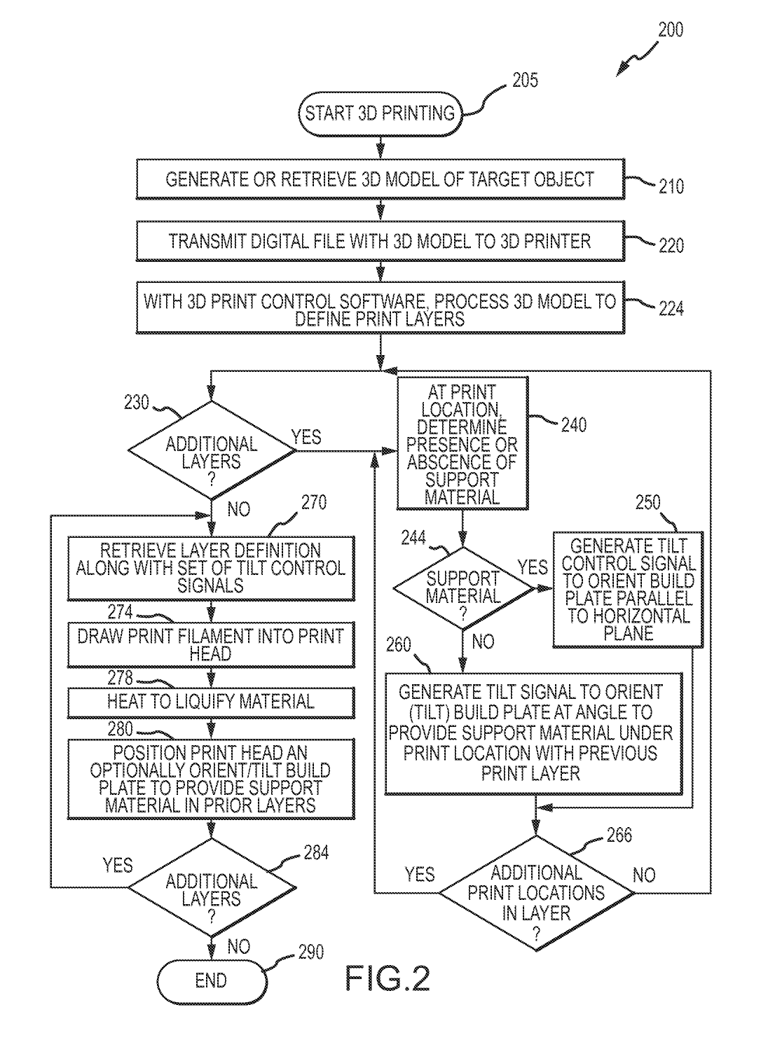

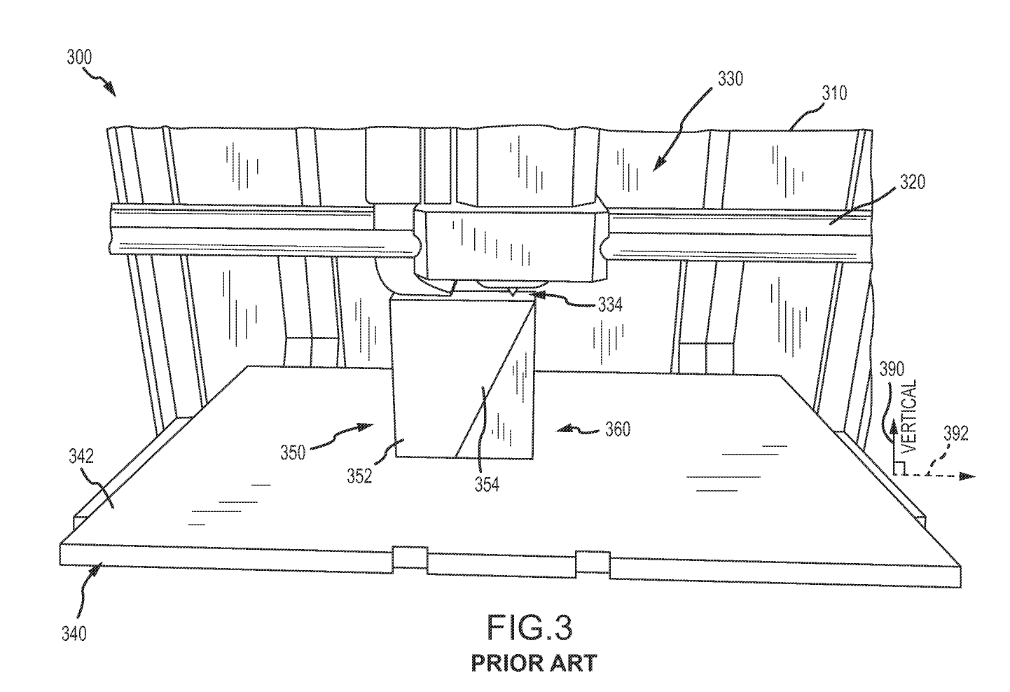

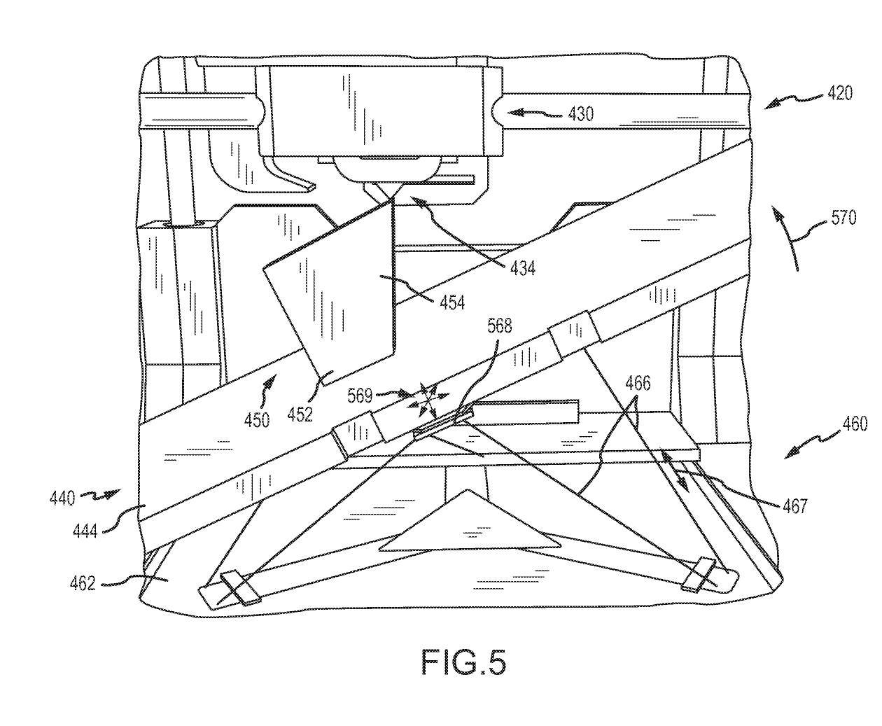

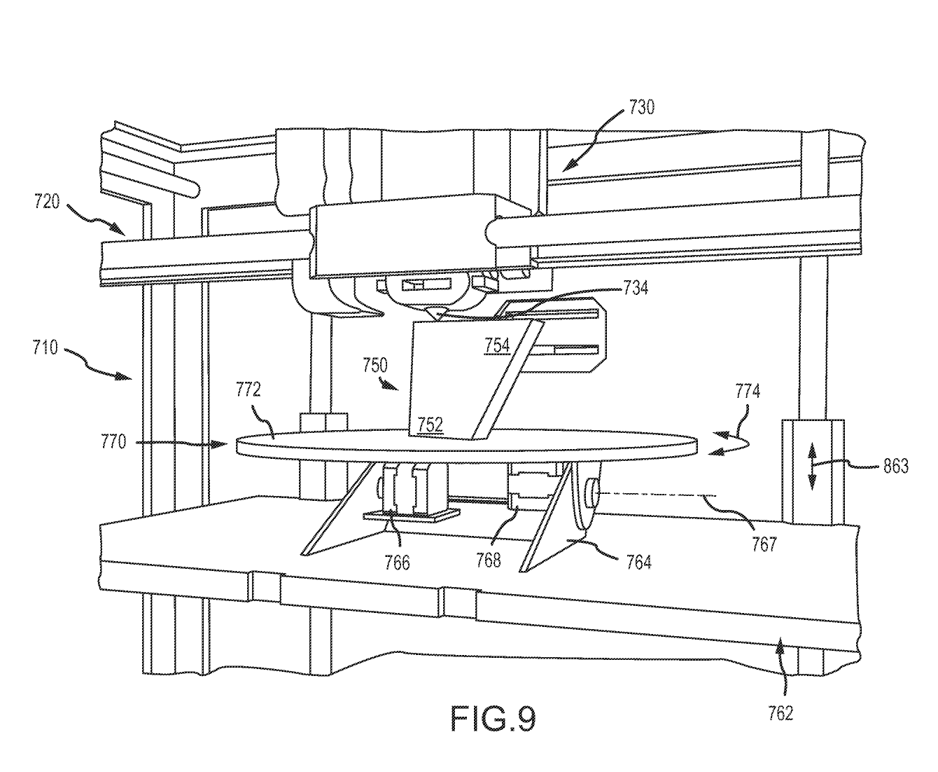

FIG. 2 illustrates a 3D printing method 200 that may be performed according to the present description such as by operation of the system 100 of FIG. 1 or the 3D printers shown in FIGS. 3-9. The method 200 starts at 205 such as with communicatively linking a printer interface system/computer with a 3D printer. At 210, the method 200 includes generating or retrieving a 3D model of the target object, which may involve generating the digital file 162 with the printer interface system 150 of FIG. 1 as discussed above. The method 200 then continues at 220 with transmitting a digital file defining this 3D model, such as file 169, to a 3D printer, such as printer 110, for use in printing a 3D object

At step 224, the method 200 continues with using 3D print control software (such as program 134) to the 3D model to define the print layers. This step 224 may involve using a slicer or similar program to define a plurality of thin slices of the model to print sequentially with a 3D printer (such as an FFM printer) or layer-by-layer. Each layer includes a number of print locations (or voxels that may correspond with X-Y coordinates) where the 3D printer will be used (and positioned) to deposit a volume of liquid plastic to form the layer. The method 200 continues at 230 with a determination of whether there are additional layers to process.

If yes, the method 200 continues at 240 with determining at a next print location whether or not there is (or will be during actual printing operations) support material provided by a previously printed portion of the model (e.g., a lower or previously printed layer). If at 244, support material is found the method 200 continues at 250 with generating a tilt control signal to orient the build plate parallel to the horizontal plane. If at 244 support material is absent in the print model for the current print location or voxel, the method 200 continues at 260 with generating a tilt control signal to orient or tilt the build plate to an angle(s) to provide support material under the print location. In contrast to prior 3D printing methods, the “support material” is provided using material to be printed at other locations and/or in other layers such as the immediately previous print layer. The method 200 then continues at 266 with determining whether or not there are additional print locations or material that needs to be printed in the current print layer. If yes, the method 200 continues at 240 with determining the presence or absence of support material for the next print location. If no, the method 200 continues at 230 with determining whether or not there are additional layers to be processed for support material and tilt angles in the digital model.

Once all layers have been processed through steps 240-266, the method 200 continues at 270 with retrieving a layer definition from the print control file in memory. The layer definition includes a tilt control signal for each print location for controlling a tilt adjustment mechanism to orient an upper or print surface of a build plate. This may involve rotating the tilt plate about a single axis. In other cases, the plate may be moved with multi-degree of freedom motion to orient the build plate and an in-process 3D object relative to an outlet of a print nozzle (e.g., place support material for the next print location vertically below the nozzle's outlet). In step 274, print material or filament is drawn into the print head, and, in step 278, the material is heated to melt or liquefy to allow deposition via the nozzle.

In step 280, the method 200 continues with positioning the print head sequentially at each print location in the print layer (and/or moving the surface of the build plate relative to the print head). Concurrently, at each print location of the print layer, the build plate is tilted or left in its prior print angle (e.g., retained parallel to horizontal) to assure that support material is provided below the outlet of the print nozzle (e.g., previously deposited or extruded material is aligned with a vertical axis passing through the outlet such that gravity causes the extruded material to land upon the previously deposited or extruded material of the 3D object). At 284, the method 200 determines after a layer is fully printed whether or not there are additional layers to be printed in the print model. If not, the method 200 ends at 290, and, if more layers need to be printed, the method 200 continues at 270 with retrieving a next layer definition.

FIG. 3 illustrates a conventional 3D printer 300 during its use to print a 3D object 350. The 3D printer 300 includes a housing or support frame 310 upon which a print head positioning and support assembly 320 is mounted. A print head 330 is included that can be positioned (e.g., at particular X-Y print coordinates in each print layer) by operation of the assembly 320 during print operations. The print head 330 may be an FFM print head that heats plastic filament that is then extruded from a print nozzle 334 onto an upper surface 342 of a build plate 340.

In this printer 300, the build plate 340 is stationary with the surface 342 retained in a horizontal position as shown with its longitudinal axis (or a plane extending through surface 342) 392 being perpendicular to vertical or a vertical axis/plane 390. In other printers, the build plate 340 may be moved along the vertical axis 390 as each layer is printed, but the surface 342 is horizontally oriented as the plate 340 is moved vertically up and down.

In this conventional printer 300, support material must be printed for any overhanging or cantilevered portions of a printed object. In the example of FIG. 3, the 3D object 350 includes a first or base portion or element 352 that may be formed by printing a plurality of layers. The object 350 also includes a second or upper portion or element 354 that overhangs from the base element 352. To print the object 350, therefore, the 3D printer 300 is operated to print additional material to provide a support structure 360 underneath or vertically below the overhanging element 354. The support structure 360 is printed beginning with the initial layers along with the layers of the first or base element 352, and, upon completion of printing, the additional material of the support structure 360 has to be removed with additional fabrication processes, which may include sanding, polishing, and painting. The printing of the support structure 360 significantly increases the length of time required to print the 3D object 350 with the 3D printer.

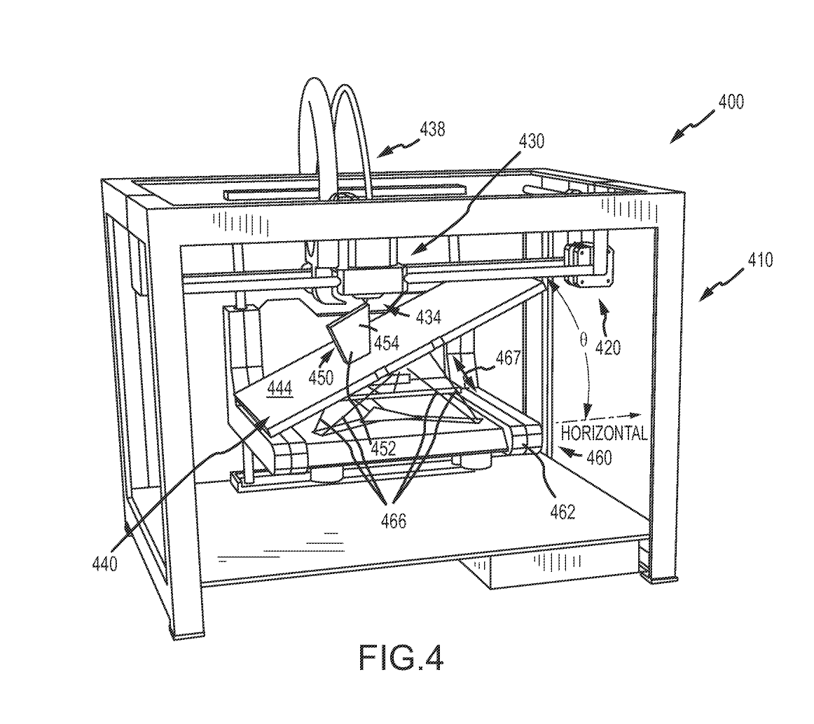

FIGS. 4-6 illustrate a 3D printer 400 configured to one embodiment of the description to perform 3D printing without the need for printing an additional support structure for overhanging elements of a 3D object. The 3D printer 400 includes a housing or support frame 410 upon which a print head support and positioning assembly 420 is mounted. A print head 430, such as an FFM print head, is provided in the 3D printer 400 and, during operations of the 3D printer, the assembly 420 is used to position a print nozzle (or its outlet) 434 in numerous print locations as may be defined for each of a large number of print layers for a modeled 3D object. Print material 438 is drawn into the print head 430 and heated to provide liquid material that can be extruded from the print nozzle 434.

The 3D printer 400 also includes a build plate 440 with an upper surface or print surface 444 that is facing or exposed to the print nozzle 434. The upper surface 444 may be planar as shown, but this is not required to practice the 3D printer 400. Significantly, the 3D printer 400 also includes a tilt adjustment or print angle-defining mechanism 460 that functions to orient the build plate 440 such that the upper surface 444 is positioned as shown with arrow 570 in a range of print angles, θ, to position previously printed material from lower layers of the object 450 vertically below the print nozzle 434. The print angle, θ, in this case is measured between horizontal and a plane extending through the print or upper surface 444 of the build plate 440. The mechanism 460 may rotate the plate 440 about more than one axis, though, to provide multi-degree of freedom motion as shown with arrows 569, which may be useful in providing support material for some shapes or designs of overhanging elements (or portions of such overhanging elements).

As shown, the 3D object 450 being printed with printer 400 has a base or first portion or element 452 and also an overhanging or second portion or element 454. No additional support structure is being printed as shown in FIG. 4-6 to print the overhanging element 454 with the build plate 440 instead being oriented or tilted by the tilt adjustment mechanism 460 to place previously printed portions (or layers) of the 3D object 450 vertically below the print nozzle. To this end, the mechanism 460 may take the form of a Stewart platform as shown. Particularly, the mechanism 460 includes a base 462 and six linear actuators 466 pivotally attached at a first end to the base 462 and at a second end to couplings 568 on the build plate 440.

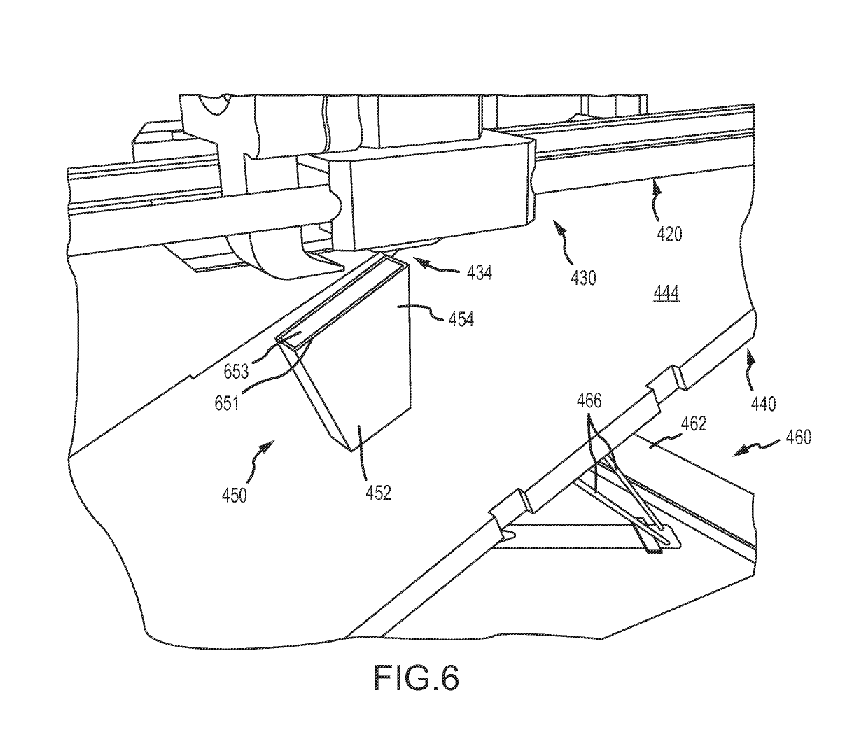

By selective actuation as shown with arrows 467, the length of the actuators 466 can be set or adjusted by a print controller of the 3D printer (not shown in FIG. 4 but as may take the form of controller 130 shown in FIG. 1) to move as shown at 569 and 570 to orient the upper surface 444 as needed to make sure a previously printed portion of the 3D object 450 is always below the print nozzle 434. For example, the tilt angle, θ, of the surface 444 may be set for each print location of each print layer of the print object 450. In this manner, as shown in FIG. 6, the 3D object 450 can be printed without support material including the base 452 and the overhanging element 454, which may be printed as an outer shell 651 and an in-fill 653. Each layer of the object 450 would be printed location by location (or voxel by voxel), and, as discussed with reference to FIGS. 1 and 2, a tilt angle (or, more generally, a build plate orientation) is defined for each of these print locations and the print controller transmits control signals to the mechanism 460 to actuate (set the lengths of) the actuators 466 to orient the upper surface 444 to match the predefined build plate orientation (or tilt angle(s)).

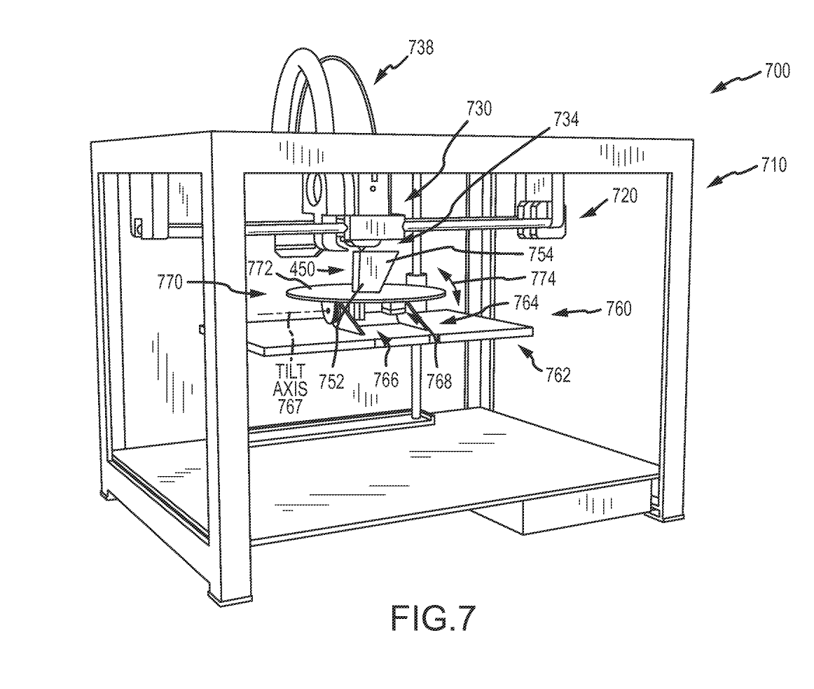

FIGS. 7-9 illustrate another embodiment of a 3D printer 700 that operates to print 3D objects such as object 750 without the need for printing additional support structures. The 3D printer 700 includes a housing or support frame with a print head support assembly 720 for supporting and selectively positioning a print head 730. A supply filament 738 is used to provide print material to the print head 730, which heats and extrudes it in liquid form via a print nozzle 734. The assembly 720 may be controlled by a print controller (as shown in FIG. 1) to position the nozzle 734 of the print head for printing layers of a print object 750, such as by moving to differing X-Y coordinates.

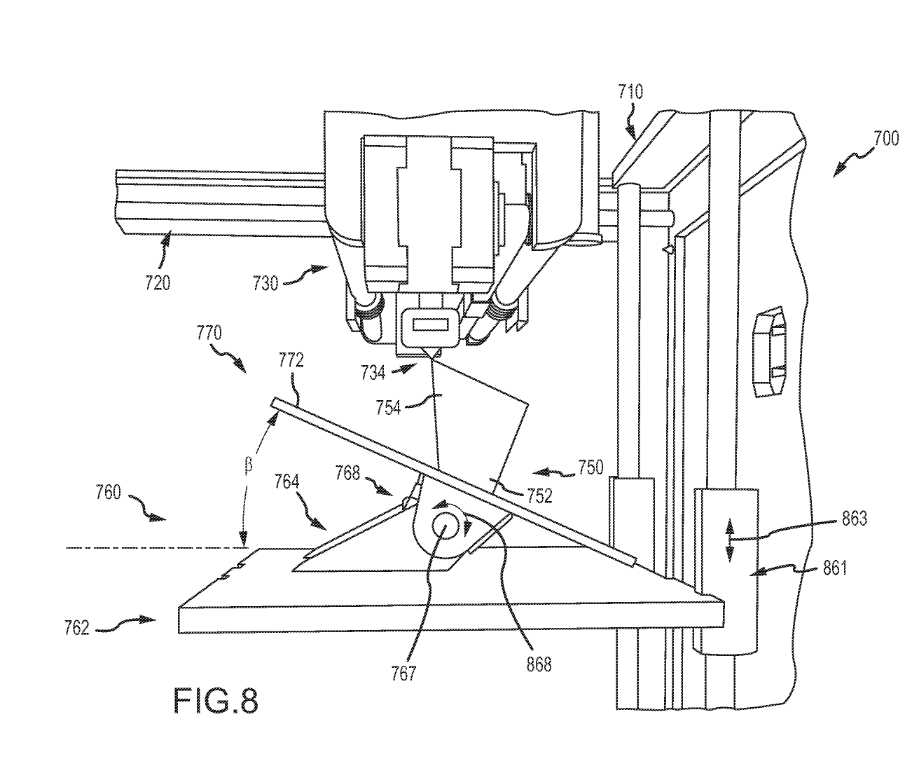

The 3D printer 700 also includes an assembly 760 that is configured to position a print surface (i.e., upper or print surface 772 of a build plate 770) and an in-process 3D object 750 at a desired orientation relative to the print nozzle 734 to ensure new material is always printed on top of previously printed material. To this end, the assembly 760 includes a base or platform 762 that may be stationary or as shown in FIG. 8 with arrows 863 may moved vertically up and down (along a Z-axis) by vertical positioning devices 861 coupled with the housing or support frame 710 of the 3D printer 700. In this printer 700, the print head 730 may not be raised and lowered (e.g., the print nozzle 734 remains in a single horizontal plane and the movements 863 are used to move the print surface 772 and its in-process 3D object relative to the print nozzle 734 to print the object's layers).

The assembly 760 also includes a pivotal mount assembly (or tilt mount/bracket(s)) 764 that pivotally couples the build plate 770 to the base or platform 762. The build plate 770 may be a rotating or rotatable disc that can be selectively rotated by a print controller to rotate as shown with arrow 774 about a center vertical axis to position the 3D object 750 relative to the print nozzle 734. Further, the 3D printer 700 is adapted for printing overhanging portions of modeled objects without the need for additional support structures. For example, the 3D object 750 is shown to include a base or first element 752 that could be printed on a horizontal plate without support structure, but the object 750 also includes an overhanging element 754.

To print the overhanging element 754, the assembly 760 includes a tilt motor 766 that can be controlled by a print controller of the printer 700 to rotation as shown with arrows 868 the build plate 770 about a tilt axis 767 extending through the assembly 764. Such tilting or rotating 868 causes the tilt or print angle, β, of the upper surface 772 of the build plate 770 (as measured between the horizontal and the upper surface 772) to be adjusted from 0 degrees (or parallel to horizontal) to a desired print angle that helps to place previously printed portions of the 3D object (in-process part) under the print nozzle 734 as can be seen in FIG. 8. In addition to this degree of motion (tilting about tilt axis 767), the assembly 760 may also include a yaw motor or actuator 768 that is coupled to the assembly 764 and/or build plate 770 and operable by a print controller to cause the build plate 770 to selectively yaw, which may be useful to orient the upper surface 772 and the 3D object 750 upon this surface 772 to vertically align previously printed material of the object 750 below the print nozzle 734 during printing of the overhanging upper element 754.

As discussed with reference to FIGS. 1 and 2, the positions (including tilt angle(s)) for the surface 772 relative to the print nozzle 734 may be defined for each print location of each print layer for the 3D object, and a print controller of the 3D printer 700 may use these definitions to provide a set of control signals to the tilt motors/actuators 766, 768 to move the build plate 770 about one or more axes to orient the upper surface 772 to provide material of a lower or earlier-printed layer of the object 750 below the nozzle 734 (i.e., to have the print location and material of a prior layer aligned with a vertical axis of the print nozzle 734).

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

We claim:

1. An apparatus for fabricating a physical three dimensional (3D) object, comprising:
a print head with a nozzle for extruding print material;
a build plate with an upper surface receiving the print material extruded from the nozzle, whereby the 3D object is formed on the upper surface of the build plate; and
a tilt adjustment mechanism supporting the build plate and tilting the build plate about at least one axis to orient the upper surface and the 3D object relative to the nozzle during the extruding of the print material from the print head.

2. The apparatus of claim 1, wherein, after a first layer of the print material is extruded upon the upper surface, the tilting is then performed such that a previously extruded portion of the print material is vertically aligned with the nozzle to receive additional portions of the print material extruded to form an overhanging element of the 3D object in a non-tilted position.

3. The apparatus of claim 1, wherein, during the extruding of the print material from the nozzle, the tilting sets a tilt angle of the build plate to a plurality of differing angles in the range of 0 to 60 degrees as measured between a horizontal plane and the upper surface.

4. The apparatus of claim 1, further comprising a print controller operating the print head and the tilt adjustment mechanism to extrude the print material from the nozzle in a plurality of layers defined in a print model of the 3D object with each of the layers having a plurality of print locations, wherein the tilting provided to the build plate to orient the upper surface is defined for each of the print locations in each of the layers.

5. The apparatus of 4, wherein the print model includes an overhanging element of the 3D object and wherein the tilting is defined to position the print material of a previously extruded one of the layers vertically below the nozzle during the printing of portions of the layers associated with the overhanging element, whereby no additional support structure is provided for the 3D object during the extruding of the print material.

6. The apparatus of claim 1, wherein the tilt adjustment mechanism is configured to provide multi-degree of motion of the build plate during the tilting.

7. The apparatus of claim 6, wherein the tilt adjustment mechanism is configured as a Stewart platform.

8. The apparatus of claim 1, wherein the build plate comprises a rotatable disk and the tilt adjustment mechanism is configured to tilt the rotatable disk about a tilt axis to orient the upper surface relative to the nozzle during the extruding of the print material.

9. The apparatus of claim 8, wherein the tilt adjustment mechanism is further configured to provide yaw movement of the build plate during the tilting to orient the upper surface relative to the nozzle.

10. A method for forming a 3D object, comprising:
depositing a liquid print material at a plurality of print locations defined for a first print layer; and
for each additional print layer:
at a next print location, determining a presence or absence of support material in a previously deposited print layer;
when the presence of the support material is determined, retaining an upper surface of a build plate parallel to a horizontal plane and depositing the liquid print material at the next print location;
when the absence of the support material is determined, orienting the upper surface relative to the horizontal plane until a portion of one of the previously deposited print layers is vertically aligned below the next print location and then depositing the liquid print material at the next print location; and
repeating the determining, the retaining, and the orienting steps for all additional print locations in the additional print layer.

11. The method of claim 10, wherein the orienting comprises adjusting a tilt angle of the upper surface from being parallel to the horizontal plane to an angle in the range of 0 to 75 degrees.

12. The method of claim 11, wherein the adjusting is performed by transmitting a tilt control signal to operate a tilt adjustment mechanism to rotate the build plate about at least one tilt axis.

13. The method of claim 12, wherein the tilt adjustment mechanism is configured as a Stewart's platform.

14. The method of claim 12, wherein the tilt adjustment mechanism comprises a rotatable disk and a tilt actuator tilting the rotatable disk about the tilt axis in response to the tilt control signal.

15. The method of claim 10, wherein the orienting step comprises receiving tilt control signals from a print controller and, in response, tilting the upper surface about one or more tilt axes to place the portion of one of the previously deposited print layers vertically below an outlet of a print head.

16. A 3D printer, comprising:
a build plate with a planar upper surface;
a print head with a print nozzle through which a print material is output onto the planar upper surface of the build plate to form a 3D object;
a print angle-defining mechanism orienting the build plate relative to the print nozzle, wherein the planar upper surface is positioned in a horizontal position parallel to a horizontal plane or a plurality of print positions in which the planar upper surface is not parallel to the horizontal plane; and
a print controller transmitting control signals to the print angle-defining mechanism to control the orienting of the build plate for print locations of each of a plurality of print layers defined in a digital print model of the 3D object.

17. The 3D printer of claim 16, wherein, after a first layer of the 3D object is printed on the planar upper surface, the orienting aligns a portion of a previously printed one of the print layers vertically below the print nozzle at each of the print locations.

18. The 3D printer of claim 16, wherein the print angle-defining mechanism comprises a Stewart's platform assembly.

19. The 3D printer of claim 16, wherein the print angle-defining mechanism comprises a motor rotating the build plate about a tilt axis, whereby the orienting selectively defines a print angle measured between a horizontal plane and the planar upper surface of the build plate.

20. The 3D printer of claim 19, wherein the upper surface of the build plate is rotatable about a central axis to reposition the 3D object relative to the print nozzle.
